(19) United States
(12) Patent Application Publication
(10) Pub. No.: US 2025/0020093 A1
(43) Pub. Date: Jan. 16, 2025

(54) EVAPORATED FUEL TREATMENT DEVICE AND MANUFACTURING METHOD OF EVAPORATED FUEL TREATMENT DEVICE

(71) Applicant: FUTABA INDUSTRIAL CO., LTD., Okazaki-shi (JP)

(72) Inventor: Koya Kato, Okazaki-shi (JP)

(21) Appl. No.: 18/758,000

(22) Filed: Jun. 28, 2024

(30) Foreign Application Priority Data
Jul. 13, 2023 (JP) 2023-115102

(51) Int. Cl. F02M 25/08; B01D 53/04

(52) U.S. Cl. CPC F02M 25/0854; B01D 53/0407; B01D 2259/4516

(57) ABSTRACT

An evaporated fuel treatment device according to one aspect of the present disclosure includes a hollow case and an adsorbent agglomerate. The hollow case includes an inner wall that defines an inner space of the hollow case. The adsorbent agglomerate is accommodated in the inner space that is surrounded by the inner wall of the hollow case. The adsorbent agglomerate is configured to adsorb an evaporated fuel flowing into the inner space. The adsorbent agglomerate is accommodated in the inner space in a state where a peripheral part of the adsorbent agglomerate is at least partially embedded in the inner wall of the hollow case.

### CROSS-REFERENCE TO RELATED APPLICATIONS

This application claims the benefit of Japanese Patent Application No. 2023-115102 filed on Jul. 13, 2023 with the Japan Patent Office, the entire disclosure of which is incorporated herein by reference.

### BACKGROUND

The present disclosure relates to an evaporated fuel treatment device and a manufacturing method of an evaporated fuel treatment device.

An evaporated fuel treatment device conventionally known is a vehicle-mounted canister. The canister adsorbs an evaporated fuel coming from a vehicle fuel tank, thereby inhibiting release of the evaporated fuel into the atmosphere. The canister is disclosed in Japanese Unexamined Patent Application Publication No. 2013-231380, Japanese Unexamined Patent Application Publication No. 2004-143950, and Japanese Unexamined Patent Application Publication No. 2023-72475.

The canister adsorbs the evaporated fuel with an adsorbent. The canister desorbs a fuel from the adsorbent using the air introduced therein, and then supplies it to an engine. In an example canister, an adsorbent agglomerate is arranged in an adsorption chamber that communicates with an atmosphere port. The adsorbent agglomerate can be, for example, a block-shaped aggregate of adsorbents made from solidified activated carbon.

### SUMMARY

Conventionally, the adsorbent agglomerate having a larger diameter than the adsorption chamber is prepared. In order to keep the adsorbent agglomerate fixed inside the adsorption chamber even when a vehicle is vibrating, the adsorbent agglomerate is mounted in a compressed state inside the adsorption chamber.

However, if the adsorbent agglomerate is mounted inside the adsorption chamber under compression, there has been a possibility that the adsorbent agglomerate could break, and its fragments could cause clogging of filters. As a result of this, there has been a possibility that ventilation resistance of the canister could deteriorate.

Accordingly, in one aspect of the present disclosure, it is desirable to provide a novel technique that enables the adsorbent agglomerate to be fixed, without compression, inside the evaporated fuel treatment device.

In one aspect of the present disclosure, an evaporated fuel treatment device is provided. The evaporated fuel treatment device comprises a hollow case and an adsorbent agglomerate. The hollow case includes an inner wall that defines an inner space of the hollow case. The adsorbent agglomerate is accommodated in the inner space that is surrounded by the inner wall of the hollow case.

The adsorbent agglomerate is configured to adsorb an evaporated fuel flowing into the inner space. In one aspect of the present disclosure, the adsorbent agglomerate is accommodated in the inner space in a state where a peripheral part of the adsorbent agglomerate is at least partially embedded in the inner wall of the hollow case.

Fixing the adsorbent agglomerate by embedding it in the inner wall of the hollow case makes it possible to properly fix the adsorbent agglomerate inside the evaporated fuel treatment device without compression. Accordingly, it is possible to inhibit the adsorbent agglomerate from breaking apart due to compression.

In one aspect of the present disclosure, the adsorbent agglomerate may have a surface with porosity. The adsorbent agglomerate may be embedded in the inner wall in a state where a material forming the inner wall has entered a plurality of pores contained in the surface. Such an embedding makes it possible to properly fix the adsorbent agglomerate inside the evaporated fuel treatment device without compression.

In one aspect of the present disclosure, the adsorbent agglomerate may be accommodated in the inner space of the hollow case such that the peripheral part of the adsorbent agglomerate is at least partially embedded in the inner wall of the hollow case by forming the hollow case including the adsorbent agglomerate by insert molding. The insert molding makes it possible to properly fix the adsorbent agglomerate inside the evaporated fuel treatment device without compression.

In one aspect of the present disclosure, the adsorbent agglomerate may have a circumferential edge arranged along the inner wall of the hollow case. The circumferential edge of the adsorbent agglomerate may be embedded in the inner wall of the hollow case. This embedding of the circumferential edge allows close contact between the inner wall of the hollow case and the circumferential edge of the adsorbent agglomerate. Accordingly, it is possible to properly reduce outflow of the evaporated fuel.

In one aspect of the present disclosure, the evaporated fuel treatment device may comprise an outer case including a charge port for the evaporated fuel. The outer case may form therein a flow passage for a gas containing the evaporated fuel flowing in from the charge port. The hollow case accommodating the adsorbent agglomerate may be formed as a separate member from the outer case. The hollow case may be arranged in the flow passage for the gas, in the outer case. Forming the hollow case accommodating the adsorbent agglomerate as a separate member from the outer case makes it possible to easily fix the adsorbent agglomerate inside the evaporated fuel treatment device without compression.

In one aspect of the present disclosure, the hollow case may comprise a case body and a connecting port. The case body may include the inner wall that defines the inner space, and may be configured to accommodate the adsorbent agglomerate. The connecting port may be configured to introduce a gas containing the evaporated fuel into the inner space. The adsorbent agglomerate may be accommodated in the inner space of the case body in a state where the adsorbent agglomerate is embedded in the inner wall so that the adsorbent agglomerate adsorbs the evaporated fuel contained in the gas introduced from the connecting port.

In one aspect of the present disclosure, the hollow case may comprise the case body and a lid. The case body may include an open end and the inner wall that defines the inner space, and may be configured to accommodate the adsorbent agglomerate. The lid may be configured to be attached to the case body at a specified position in the case body so as to close at least a part of the open end.

In one aspect of the present disclosure, a manufacturing method of an evaporated fuel treatment device may be provided. The evaporated fuel treatment device may comprise a hollow case and an adsorbent agglomerate. The manufacturing method may comprise preparing a mold to form the hollow case. The hollow case includes an inner wall that defines an inner space. The manufacturing method may comprise arranging the adsorbent agglomerate at a specified position inside the mold. The adsorbent agglomerate is configured to adsorb the evaporated fuel. The manufacturing method may comprise filling a resin to form the hollow case inside the mold in a state where the adsorbent agglomerate is arranged inside the mold.

The evaporated fuel treatment device may be manufactured by filling the resin inside the mold. The adsorbent agglomerate may be accommodated in the inner space of the hollow case in a state where the peripheral part of the adsorbent agglomerate is at least partially embedded in the inner wall of the hollow case by insert molding. The insert molding makes it possible to properly fix the adsorbent agglomerate inside the evaporated fuel treatment device without compression.

In one aspect of the present disclosure, the hollow case may include, as the inner wall, a cylindrical inner wall having a central axis. The adsorbent agglomerate may have a columnar outer shape having a central axis. The mold and the adsorbent agglomerate may include respective positioning structures to align the central axis of the adsorbent agglomerate with the central axis of the hollow case.

The arranging the adsorbent agglomerate may include arranging the adsorbent agglomerate in the specified position inside the mold by positioning the adsorbent agglomerate with respect to the mold using the respective positioning structures. This method makes it possible to properly position the adsorbent agglomerate with respect to the hollow case during insert molding.

### BRIEF DESCRIPTION OF THE DRAWINGS

Example embodiments of the present disclosure will be described hereinafter by way of example with reference to the accompanying drawings, in which:

FIG. 1 is a schematic cross sectional view showing an evaporated fuel treatment device according to a first embodiment;

FIG. 2 is a schematic cross sectional view showing a cartridge;

FIG. 3A is an explanatory diagram related to insert molding of a hollow case using a mold according to the first embodiment;

FIG. 3B is a schematic cross sectional view showing the hollow case formed by insert molding with the mold according to the first embodiment;

FIG. 4 is a schematic cross sectional view showing an evaporated fuel treatment device that corresponds to a modified example of the first embodiment;

FIG. 5 is a schematic perspective view showing an adsorbent and a mold in the modified example;

FIG. 6A is an explanatory diagram related to insert molding of a hollow case using a mold according to the modified example;

FIG. 6B is a schematic cross sectional view showing the hollow case formed by insert molding with the mold according to the modified example;

FIG. 7 is a schematic cross sectional view showing an evaporated fuel treatment device according to a second embodiment; and

FIG. 8 is a schematic cross sectional view showing an evaporated fuel treatment device according to a third embodiment.

### DETAILED DESCRIPTION OF EXEMPLARY EMBODIMENTS

### Embodiment 1

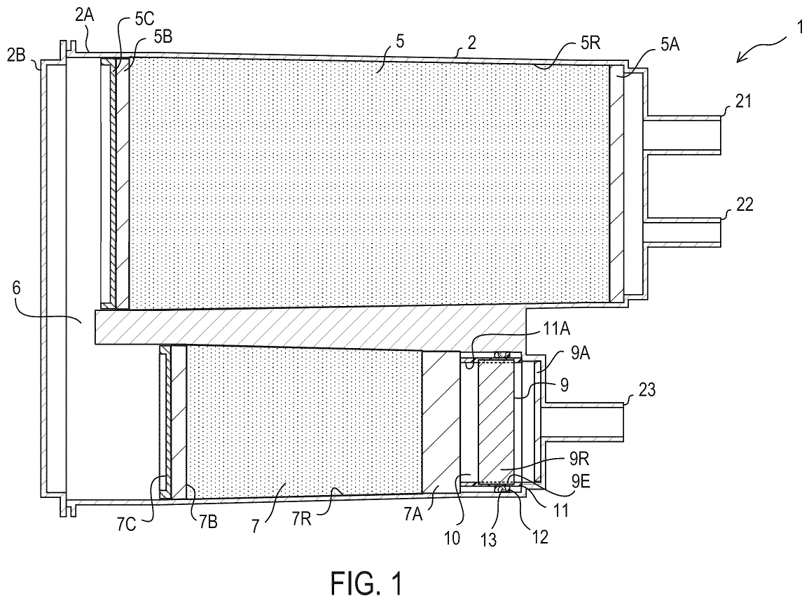

An evaporated fuel treatment device 1 according to the present embodiment shown in FIG. 1 is configured as a vehicle-mounted canister that adsorbs and desorbs an evaporated fuel generated in a vehicle fuel tank.

The evaporated fuel treatment device 1 comprises an outer case 2 and accommodates an adsorbent 5, an adsorbent 7, and an adsorbent agglomerate 9 in the outer case 2 to adsorb the evaporated fuel. The outer case 2 comprises a charge port 21, a purge port 22, and an atmosphere port 23.

The outer case 2 is configured to define an inner space. The outer case 2 includes a first adsorption chamber 5R, a communication path 6, a second adsorption chamber 7R, and a third adsorption chamber 9R in the inner space. Inside the outer case 2, as a flow passage for the gas flowing in from the charge port 21, the flow passage is formed for the gas to pass through the first adsorption chamber 5R, the communication path 6, the second adsorption chamber 7R, and the third adsorption chamber 9R.

The charge port 21 is coupled to the vehicle fuel tank via a pipe. The charge port 21 is configured to introduce the evaporated fuel generated in the fuel tank into the evaporated fuel treatment device 1. The charge port 21 functions as an inflow port for the gas containing the evaporated fuel.

The purge port 22 is coupled to an intake pipe of a vehicle engine via a purge valve. The purge port 22 is configured to supply to the engine the evaporated fuel inside the evaporated fuel treatment device 1.

The atmosphere port 23 is configured to release the gas from which the evaporated fuel has been removed into the atmosphere. Additionally, the atmosphere port 23 is configured to introduce an external air, that is, a purge air. By introducing the external air from the atmosphere port 23, the evaporated fuel adsorbed by the evaporated fuel treatment device 1 is desorbed, and then supplied to the engine via the purge port 22.

The outer case 2 comprises a main body 2A and a lid 2B. The main body 2A has an open end. The charge port 21, the purge port 22, and the atmosphere port 23 is provided with the main body 2A. Inside the outer case 2, the adsorbent 5, the adsorbent 7, the adsorbent agglomerate 9, and other necessary members are located through the open end of the main body 2A. The lid 2B is attached to the main body 2A to close the open end of the main body 2A.

The first adsorption chamber 5R is arranged in an area in the vicinity of the charge port 21 and the purge port 22 in the inner space of the outer case 2. The first adsorption chamber 5R accommodates the adsorbent 5. Examples of the adsorbent 5 include activated carbon and zeolite. In the first adsorption chamber 5R, the evaporated fuel flowing in from the charge port 21 is adsorbed on the adsorbent 5. The evaporated fuel adsorbed on the adsorbent 5 is discharged from the purge port 22.

The first adsorption chamber 5R is defined by a first filter 5A and a second filter 5B that are arranged in the inner space of the outer case 2. The first filter 5A and the second filter 5B are configured to inhibit the adsorbent 5 from passing through, but they are configured to allow the gas to pass through.

The first filter 5A separates a space that is communicating with the charge port 21 and the purge port 22, and the first adsorption chamber 5R from each other. The second filter 5B separates a communication path 6 communicating with the second adsorption chamber 7R, and the first adsorption chamber 5R from each other.

The second filter 5B is pressed toward the charge port 21 and the purge port 22 via a grid 5C. This causes the adsorbent 5 to be held between the filter 5A and the filter 5B inside the first adsorption chamber 5R. The grid 5C may be formed in a grid, slit, or multi-pore shape.

Of the evaporated fuel flowing in from the charge port 21, the evaporated fuel not adsorbed on the adsorbent 5 in the first adsorption chamber 5R moves through the communication path 6 to the second adsorption chamber 7R, and is then adsorbed on the adsorbent 7 in the second adsorption chamber 7R.

The communication path 6 is located in an area where the main body 2A and the lid 2B are adjacent to each other in the inner space of the outer case 2, and forms the flow passage between the first adsorption chamber 5R and the second adsorption chamber 7R for the gas containing the evaporated fuel to pass through.

The second adsorption chamber 7R is arranged such that the gas moves freely between the first adsorption chamber 5R and the second adsorption chamber 7R through the communication path 6. As shown in FIG. 1, the first adsorption chamber 5R and the second adsorption chamber 7R are arranged parallel to each other, adjacent to the communication path 6. More specifically, the second adsorption chamber 7R is arranged to be lined with the first adsorption chamber 5R in a radial direction of the first adsorption chamber 5R so that a direction of gas flow in the second adsorption chamber 7R becomes parallel with a direction of gas flow in the first adsorption chamber 5R.

The second adsorption chamber 7R accommodates the adsorbent 7. Examples of the adsorbent 7 include activated carbon and zeolite. The adsorbent 7 may be made from the same material as the adsorbent 5 of the first adsorption chamber 5R, or may be made from a different material than the adsorbent 5 of the first adsorption chamber 5R.

The second adsorption chamber 7R is defined by a first filter 7A and a second filter 7B that are arranged in the inner space of the outer case 2. The first filter 7A and the second filter 7B that define the second adsorption chamber 7R are configured to inhibit the adsorbent 7 from passing through and to allow the gas to pass through.

The first filter 7A separates the second adsorption chamber 7R and a space where the third adsorption chamber 9R is to be arranged from each other. The second filter 7B separates the communication path 6 and the second adsorption chamber 7R from each other. The second filter 7B is pressed toward the second adsorption chamber 7R and the atmosphere port 23 via a grid 7C. As a result of this, the filter 7A and the filter 7B hold the adsorbent 7 between them inside the second adsorption chamber 7R. The grid 7C may be formed in a grid, slit, or multi-pore shape.

The third adsorption chamber 9R is located inside a cartridge 10, which is mounted in an area adjacent to the atmosphere port 23 in the inner space of the outer case 2. The cartridge 10 is a separate member from the outer case 2, and is accommodated in the inner space of the outer case 2.

Inside the outer case 2, a filter 9A is provided to cover a flow passage from the atmosphere port 23 to the third adsorption chamber 9R. The filter 9A is located between the atmosphere port 23 and the cartridge 10. The cartridge 10 is provided in the vicinity of the filter 9A. While the filter 9A is configured to inhibit the adsorbent agglomerate 9 from passing through, it is configured to allow the gas to pass through.

The cartridge 10 comprises a cylindrical hollow case 11 and the adsorbent agglomerate 9. The hollow case 11 comprises a cylindrical inner wall 11A that defines an inner space of the cartridge 10. The adsorbent agglomerate 9 is accommodated in the inner space surrounded by the inner wall 11A of the hollow case 11. The inner wall 11A of the hollow case 11 defines the third adsorption chamber 9R.

Provided on an outer circumference of the hollow case 11 is a ring-shaped elastic sealing member 13. Also provided on the outer circumference of the hollow case 11 is a groove 12 for positioning the sealing member 13. The sealing member 13 is positioned in the groove 12 provided on the outer circumference of the hollow case 11. With this positioning, the sealing member 13 is mounted on the outer circumference of the hollow case 11. Examples of the sealing member 13 include an O-ring.

The cartridge 10 is mounted inside the outer case 2 to be positioned by the sealing member 13. In one example, an inner circumference of the outer case 2 and the outer circumference of the hollow case 11 form circles. The outer circumference of the hollow case 11 has a smaller diameter than the inner circumference of the outer case 2. In this example, the mounting is performed in such a way that the cartridge 10 with a circular section fits into the inner space of the outer case 2 with a circular section.

In a state where the cartridge 10 is mounted at a correct position inside the outer case 2, the sealing member 13 comes into contact with an inner circumferential surface of the outer case 2 and elastically deforms. As a result of this, the sealing member 13 closes a gap between the inner circumferential surface of the outer case 2 and an outer circumferential surface of the hollow case 11 so as not to allow the gas containing the evaporated fuel from passing through the gap. Moreover, the cartridge 10 is fixed inside the outer case 2 by the elastic force of the sealing member 13 so that it will not move out of position.

The adsorbent agglomerate 9 is accommodated inside the hollow case 11 so as to cover an entire cross section of the hollow case 11, which is perpendicular to a central axis thereof, in the inner space surrounded by the inner wall 11A of the hollow case 11.

The adsorbent agglomerate 9 is a columnar adsorbent agglomerate, an outer shape of which corresponds to that of the inner space of the hollow case 11. In one example, the hollow case 11 is a round cylindrical case and the adsorbent agglomerate 9 is a round columnar adsorbent agglomerate.

The adsorbent agglomerate 9 is, for example, an aggregate of granular or fibrous adsorbents. For example, the adsorbent agglomerate 9 can be an aggregate of granular adsorbents such as activated carbon or zeolite. In another example, the adsorbent agglomerate 9 can be an adsorbent agglomerate formed with fibrous activated carbon.

Characteristic of the present embodiment is that the adsorbent agglomerate 9 is accommodated inside the hollow case 11 in such a way that a circumferential edge 9E of the adsorbent agglomerate 9 is embedded in the inner wall 11A of the hollow case 11 along an entire inner circumferential direction of the hollow case 11. The adsorbent agglomerate 9 is embedded in the hollow case 11 by insert molding. The circumferential edge 9E is an edge of the adsorbent agglomerate 9 around its axis.

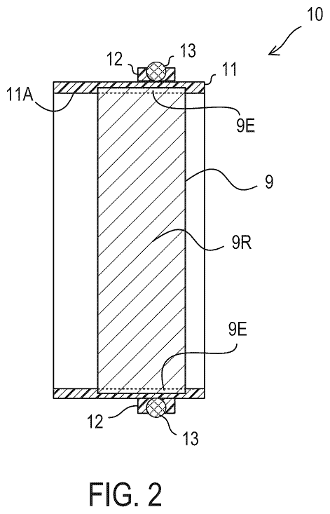

More specifically, the hollow case 11 is formed as one piece with the adsorbent agglomerate 9 by insert molding. FIG. 2 illustrates that the circumferential edge 9E of the adsorbent agglomerate 9 is embedded in the inner wall 11A of hollow case 11.

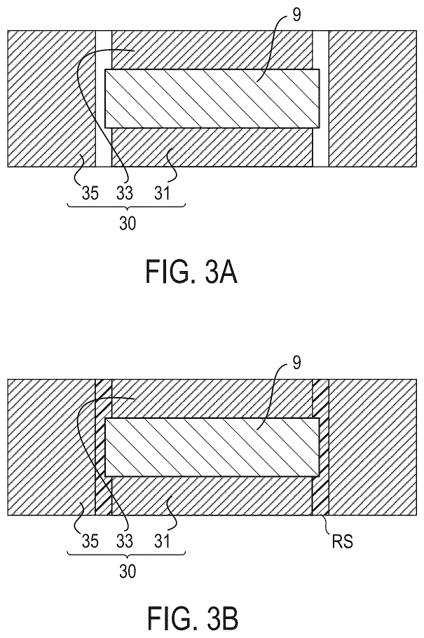

The cartridge 10 is manufactured by preparing a mold 30 for forming the hollow case 11 as shown in FIG. 3A and by filling a resin RS into an inside of the mold 30 in a state where the adsorbent agglomerate 9 is arranged in a specified position inside the mold 30 as shown in FIG. 3B.

The adsorbent agglomerate 9 is made of a porous material. Thus, the adsorbent agglomerate 9 has a surface with porosity. When the resin RS is poured into the mold 30 prior to curing, the resin RS, which makes the hollow case 11, flows into multiple pores contained in the surface of the adsorbent agglomerate 9. The resin RS is cured in a state where it has flowed into the multiple pores, whereby the adsorbent agglomerate 9 is accommodated in the hollow case 11 in a state where it is embedded in the inner wall 11A of the hollow case 11.

As shown in FIG. 3A, the mold 30 comprises columnar mold components 31, 33 and a cylindrical mold component 35 to form the inner space of the hollow case 11. The cylindrical mold component 35 is arranged to surround the columnar mold components 31, 33. The columnar mold components 31, 33 comprise a first mold component 31 and a second mold component 33.

The first mold component 31 supports the adsorbent agglomerate 9 from below to arrange the adsorbent agglomerate 9 at a specified position in axial directions of the hollow case 11. The second mold component 33 is arranged on the adsorbent agglomerate 9.

Inside the cylindrical mold component 35, the adsorbent agglomerate 9 is arranged between the columnar first mold component 31 and the columnar second mold component 33. At this point, the adsorbent agglomerate 9 is arranged inside the mold 30 so that a central axis of the adsorbent agglomerate 9, a central axis of the cylindrical mold component 35, and central axes of the columnar mold components 31, 33 coincide with each other. Prepared as the adsorbent agglomerate 9 is a columnar adsorbent agglomerate having a diameter larger than outer circumferences of the columnar mold components 31, 33, and smaller than an inner circumference of the cylindrical mold component 35.

The resin RS is filled in a gap between the cylindrical mold component 35 and the columnar mold components 31, 33, whereby the cartridge 10 is manufactured with an entire circumferential edge 9E of the adsorbent agglomerate 9 embedded in the inner wall 11A of the hollow case 11.

In the evaporated fuel treatment device 1 according to the present embodiment, the evaporated fuel introduced from the charge port 21 is adsorbed on the adsorbent 5 in the first adsorption chamber 5R. The evaporated fuel that could not be fully adsorbed in the adsorption chamber 5R moves through the communication path 6 to the second adsorption chamber 7R, and then adsorbed on the adsorbent 7 in the second adsorption chamber 7R.

The evaporated fuel that could not be fully adsorbed in the second adsorption chamber 7R moves to the third adsorption chamber 9R, and then adsorbed on the adsorbent agglomerate 9 in the third adsorption chamber 9R. The gas, from which the evaporated fuel has been removed by adsorption, is released from the atmosphere port 23.

In addition to the above, with an air supply from the atmosphere port 23, the evaporated fuels that have been adsorbed on the adsorbent 5, the adsorbent 7, and the adsorbent agglomerate 9, each of which is located in the first adsorption chamber 5R, the second adsorption chamber 7R, and the third adsorption chamber 9R, respectively, are discharged from the purge port 22 to the engine.

### Effects

In the present embodiment, the adsorbent agglomerate 9 is fixed so as to be embedded in the inner wall 11A of the hollow case 11. Thus, basically no gaps are created between the inner wall 11A of the hollow case 11 and the adsorbent agglomerate 9 even when a vehicle is vibrating. The evaporated fuel is properly adsorbed on the adsorbent agglomerate 9.

In the present embodiment, the circumferential edge 9E of the adsorbent agglomerate 9 is formed as one piece with the inner wall 11A of the hollow case 11, thereby inhibiting the adsorbent agglomerate 9 from being damaged by compression. Conventionally, for fixing an adsorbent agglomerate inside the hollow case 11, an adsorbent agglomerate, which has an outer diameter larger than an inner diameter of the hollow case 11, is compressed in radial directions thereof to be accommodated inside the hollow case 11.

The compression makes it possible to make a close contact between a circumferential edge of the adsorbent agglomerate and the inner wall 11A of the hollow case 11. However, the circumferential edge of the adsorbent agglomerate receives a load due to the compression. In the conventional technique, there has been a possibility that fragments of the adsorbent agglomerate resulting from a breakage of the adsorbent agglomerate due to the load could cause clogging of the filters 7A, 9A. In other words, there has been a possibility that the breakage of the adsorbent agglomerate could cause increased ventilation resistance.

In contrast, in the present embodiment, the breakage of the adsorbent agglomerate 9 due to the compression can be reduced. Accordingly, the present embodiment can provide a highly-durable evaporated fuel treatment device 1, with which a good ventilation resistance can be maintained for a long time. The cartridge 10 can be distributed as a component of the evaporated fuel treatment device 1. The cartridge 10 itself is also an evaporated fuel treatment device in a broader sense.

### Modified Example of First Embodiment

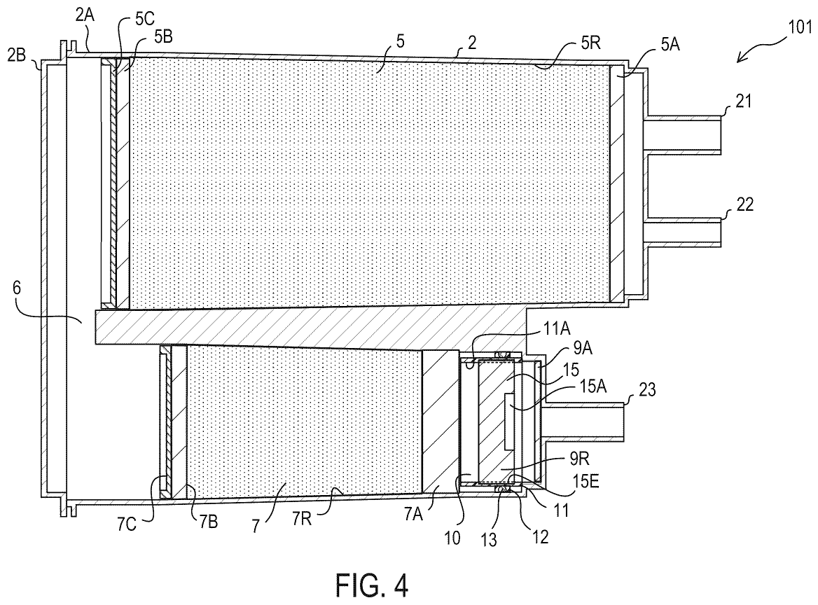

As shown in FIG. 4, in place of the aforementioned adsorbent agglomerate 9, the cartridge 10 may include therein an adsorbent agglomerate 15 having a recess 15A for use in positioning. An evaporated fuel treatment device 101, which is shown in FIG. 4 as a modified example, differs from the evaporated fuel treatment device 1 shown in FIG. 1 in that the evaporated fuel treatment device 101 comprises the adsorbent agglomerate 15 having the recess 15A in place of the aforementioned adsorbent agglomerate 9.

Nevertheless, the evaporated fuel treatment device 101 as the modified example is basically configured the same as the evaporated fuel treatment device 1 shown in FIG. 1 except for the above point. Hereinafter, portions of the evaporated fuel treatment device 101 as the modified example that are configured the same as those of the evaporated fuel treatment device 1 will be described with the same reference numbers used for corresponding portions of the evaporated fuel treatment device 1, and their detailed explanations will be omitted.

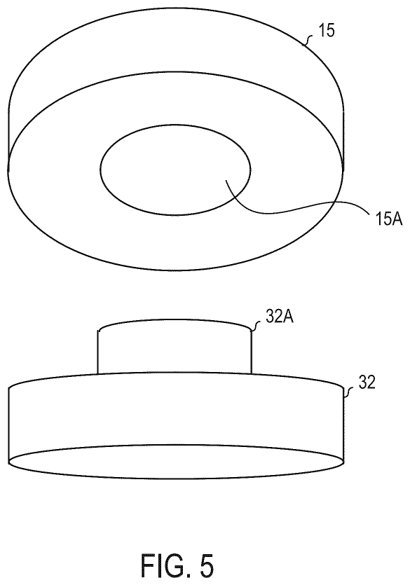

In the present modified example, inside the hollow case 11, the cartridge 10 accommodates the adsorbent agglomerate 15 having the recess 15A. When forming the hollow case 11 integrally with the adsorbent agglomerate 15 by insert molding, in place of the mold component 31, a mold component 32 shown in FIG. 5 is used.

The adsorbent agglomerate 15 has the recess 15A with a circular section, and correspondingly the mold component 32 has a projection 32A that is shaped in a round column. The projection 32A and the recess 15A are formed with dimensions such that they will not be relatively displaced in their radial directions when engaged with each other.

The projection 32A is provided on an upper surface of the mold component 32 such that a central axis of the projection 32A and a central axis of the mold component 32 coincide with each other. The recess 15A is formed on a lower surface of the adsorbent agglomerate 15 such that a central axis of the recess 15A and a central axis of the adsorbent agglomerate 15 coincide with each other.

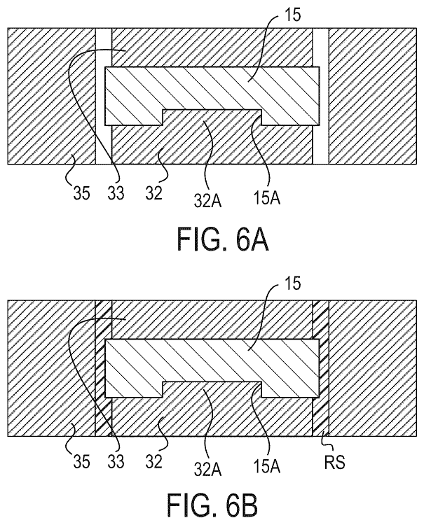

As shown in FIG. 6A, the adsorbent agglomerate 15 is arranged on the mold component 32 so as to be positioned by the engagement of the projection 32A with the recess 15A. As a result of this, the adsorbent agglomerate 15 is arranged such that its central axis coincides with the central axis of the mold component 32.

The mold component 32 is arranged such that its central axis coincides with the central axis of the cylindrical mold component 35. Thus, the adsorbent agglomerate 15 is arranged in a space enclosed by the mold components 32, 33, and 35 so that its central axis coincides with the central axis of the cylindrical mold component 35.

By pouring the resin RS in a state where the adsorbent agglomerate 15 is arranged between the mold components 32, 33, and 35, the cartridge 10 is formed as shown in FIG. 6B. In the cartridge 10, the adsorbent agglomerate 15 is accommodated in the hollow case 11 such that the central axis of the adsorbent agglomerate 15 coincides with the central axis of the hollow case 11. The circumferential edge 15E of the adsorbent agglomerate 15 is embedded in the inner wall 11A of the hollow case 11.

The projection 32A and the recess 15A function as positioning structures to position the central axis of the adsorbent agglomerate 15 with the central axis of the hollow case 11. The present embodiment makes it possible to manufacture the cartridge 10 by insert molding, in which the adsorbent agglomerate 15 is properly accommodated inside the hollow case 11, using the mold 30 comprising the mold components 32, 33, and 35.

The descriptions made so far have been directed to an example where the adsorbent agglomerate 15 has the recess 15A and the mold component 32 has the projection 32A. However, the adsorbent agglomerate 15 may have a projection and the mold component 32 may have a recess to be engaged with the projection.

### Embodiment 2

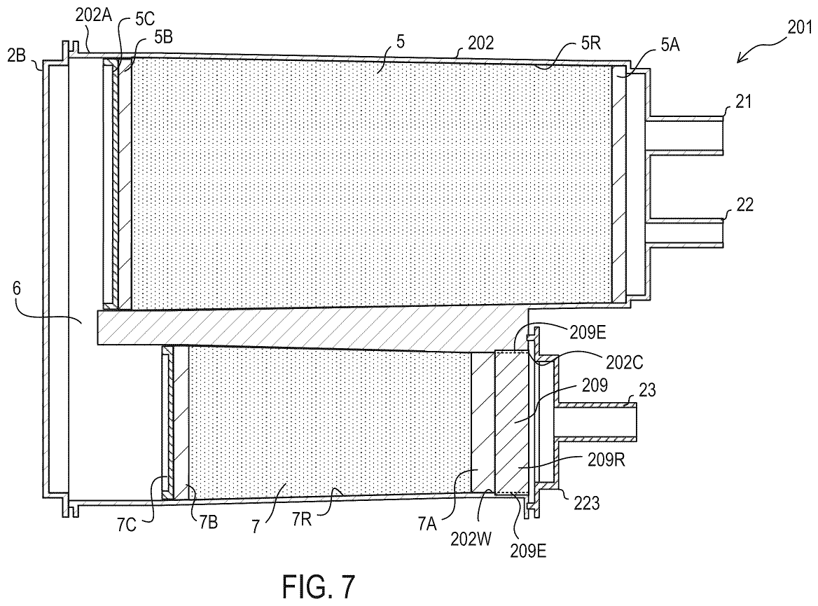

An evaporated fuel treatment device 201 shown in FIG. 7 as the second embodiment comprises an outer case 202 that does not include the atmosphere port 23. The evaporated fuel treatment device 201 comprises an adsorbent agglomerate 209 in place of the adsorbent agglomerate 9. The evaporated fuel treatment device 201 differs from the evaporated fuel treatment device 1 of the first embodiment in that a circumferential edge 209E of the adsorbent agglomerate 209 is embedded in an inner wall 202W of the outer case 202.

The evaporated fuel treatment device 201 of the second embodiment comprises a port-forming part 223, which forms the atmosphere port 23. The evaporated fuel treatment device 201 also differs from the evaporated fuel treatment device 1 of the first embodiment in that the port-forming part 223 is mounted to the outer case 202.

The evaporated fuel treatment device 201 of the second embodiment is basically configured the same as the evaporated fuel treatment device 1 of the first embodiment in configurations other than the above. Hereinafter, portions of the evaporated fuel treatment device 201 of the second embodiment that are configured the same as those of the evaporated fuel treatment device 1 will be described with the same reference numbers used in the first embodiment, and their detailed explanations will be omitted.

In the evaporated fuel treatment device 201 of the present embodiment, the outer case 202 comprises a main body 202A and the lid 2B. The main body 202A comprises the charge port 21 and the purge port 22. The lid 2B is attached to a specified portion in the main body 202A to close an open end of the main body 202A.

The outer case 202 is configured to define an inner space. The outer case 202 includes the first adsorption chamber 5R, the communication path 6, the second adsorption chamber 7R, and a third adsorption chamber 209R in the inner space. Inside the outer case 202, as the flow passage for the gas flowing in from the charge port 21, the flow passage is formed for the gas to pass through the first adsorption chamber 5R, the communication path 6, the second adsorption chamber 7R, and the third adsorption chamber 209R. The outer case 202 has an opening 202C in a position adjacent to the third adsorption chamber 209R.

The port-forming part 223 is mounted to the outer case 202 to cover the opening 202C. The port-forming part 223 may be fixed to the outer case 202 with an adhesive, or may be fixed to the outer case 202 with fixing parts such as screws.

In the first adsorption chamber 5R, the filters 5A, 5B keep the adsorbent 5 between them. In the second adsorption chamber 7R, the filters 7A, 7B keep the adsorbent 7 between them.

The adsorbent agglomerate 209 is arranged adjacent to the filter 7A in an area adjacent to the opening 202C inside an inner space of the outer case 202. The adsorbent agglomerate 209 is configured the same as the adsorbent agglomerate 9 of the first embodiment. Specifically, the adsorbent agglomerate 209 is a columnar adsorbent agglomerate, an outer shape of which corresponds to an inner circumference of the outer case 202 in which the adsorbent agglomerate 209 is accommodated.

In the present embodiment, the adsorbent agglomerate 209 is accommodated inside the outer case 202 in the area adjacent to the opening 202C. The adsorbent agglomerate 209 is accommodated in the outer case 202 in such a manner that the circumferential edge 209E of the adsorbent agglomerate 209 is embedded in the inner wall 202W of the outer case 202 along an entire inner circumferential direction of the outer case 202. Similarly to the first embodiment, the adsorbent agglomerate 209 is embedded in the inner wall 202W of the outer case 202 by insert molding.

The outer case 202 is formed of the resin RS. When the outer case 202 is formed, the adsorbent agglomerate 209 is arranged inside a mold for use in forming the main body 202A of the outer case 202. The resin RS is poured in the mold in a state where the adsorbent agglomerate 209 arranged therein. By doing so, the main body 202A of the outer case 202 is formed with the circumferential edge 209E of the adsorbent agglomerate 209 is embedded in the inner wall 202W.

The evaporated fuel treatment device 201 is completed by accommodating the filters 5A, 5B, the adsorbent 5, the grid 5C, the filters 7A, 7B, the adsorbent 7, and the grid 7C inside the main body 202A of the outer case 202, which is formed integrally with the adsorbent agglomerate 209, and by mounting the port-forming part 223 to the opening 202C. In the present embodiment, the outer case 202 corresponds to the hollow case for the evaporated fuel treatment device 201.

Also in the present embodiment, similarly to the first embodiment, the adsorbent agglomerate 209 is provided in the evaporated fuel treatment device 201 by insert molding. This makes it possible to reduce the breakage of the adsorbent agglomerate 209 caused by compression, and the increased ventilation resistance caused by adhesion of fragments of the adsorbent agglomerate 209 that generates from the breakage to the filter 7A.

### Embodiment 3

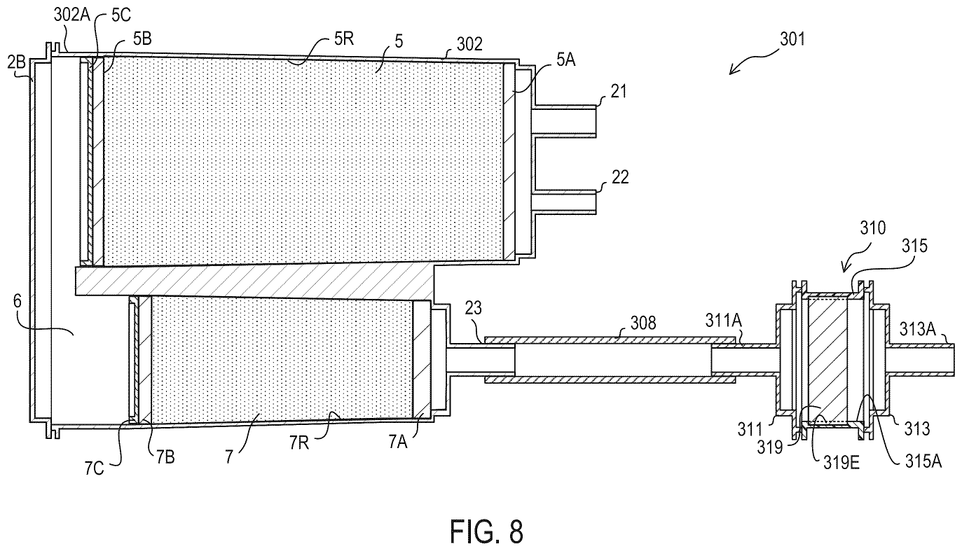

The evaporated fuel treatment device 301 shown in FIG. 8 as the third embodiment comprises an outer case 302. The evaporated fuel treatment device 301 differs from the evaporated fuel treatment device 1 of the first embodiment in that a cartridge 310 comprising an adsorbent agglomerate 319 in place of the adsorbent agglomerate 9 is arranged outside the outer case 302. The evaporated fuel treatment device 301 of the third embodiment is basically configured the same as the evaporated fuel treatment device 1 of the first embodiment in the configurations other than the above. Hereinafter, portions of the evaporated fuel treatment device 301 of the third embodiment that are configured the same as those of the evaporated fuel treatment device 1 will be described with the same reference numbers used for the first embodiment, and their detailed explanations will be omitted.

As shown in FIG. 8, the outer case 302 of the evaporated fuel treatment device 301 comprises a main body 302A and the lid 2B. The main body 302A comprises the charge port 21, the purge port 22, and the atmosphere port 23. The lid 2B is attached to the main body 302A to close an open end of the main body 302A.

The outer case 302 is configured to define an inner space. The outer case 302 includes the first adsorption chamber 5R, the communication path 6, and the second adsorption chamber 7R in the inner space. Inside the outer case 302, as the flow passage for the gas flowing in from the charge port 21, the flow passage is formed for the gas to pass through the first adsorption chamber 5R, the communication path 6, and the second adsorption chamber 7R.

In the first adsorption chamber 5R, the filters 5A, 5B keep the adsorbent 5 between them. In the second adsorption chamber 7R, the filters 7A, 7B keep the adsorbent 7 between them. The filter 7A separates a space communicating with the atmosphere port 23 and the second adsorption chamber 7R.

Connected to the atmosphere port 23 is a connecting pipe 308 that connects the cartridge 310 and the atmosphere port 23 to each other. A first end portion of the connecting pipe 308 is connected to the atmosphere port 23, and a second end portion of the connecting pipe 308 is connected to a connecting port 311A of the cartridge 310.

The cartridge 310 is connected to the atmosphere port 23 via the connecting pipe 308. The cartridge 310 is formed as an external component, which is separate from the outer case 302. The cartridge 310 comprises a connecting-port forming part 311, an atmosphere-port forming part 313, and a case body 315.

The connecting-port forming part 311, the atmosphere-port forming part 313, and the case body 315 form a hollow case of the cartridge 310. The case body 315 comprises an inner wall 315A that defines an inner space. The case body 315 is a cylindrical case body, both ends of which are open. Examples of the case body 315 include a round cylindrical case body.

The connecting-port forming part 311 is a part functioning as a lid and is attached to the case body 315 to cover a first open end of the case body 315. The connecting-port forming part 311 comprises a first end portion that forms the connecting port 311A. A second end portion of the connecting-port forming part 311 is connected to the first open end of the case body 315. The connecting port 311A functions as an introducing port to introduce the gas containing the evaporated fuel into an inner space of the cartridge 310.

The atmosphere-port forming part 313 is a part functioning as a lid and is attached to the case body 315 to cover a second open end of the case body 315. A first end portion of the atmosphere-port forming part 313 is connected to the second open end of the case body 315. The atmosphere-port forming part 313 comprises a second end portion opposite to the first end portion, which forms the atmosphere port 313A.

The adsorbent agglomerate 319 is accommodated in an inner space that is surrounded by the inner wall 315A of the case body 315. The adsorbent agglomerate 319 is configured in the same manner as the adsorbent agglomerate 9 of the first embodiment. The adsorbent agglomerate 319 is accommodated in the case body 315 such that that a circumferential edge 319E of the adsorbent agglomerate 319 is embedded in the inner wall 315A of the case body 315.

Specifically, the case body 315 is formed as one piece with the adsorbent agglomerate 319 by insert molding. The adsorbent agglomerate 319 has a surface with porosity. By the aforementioned insert molding, the adsorbent agglomerate 319 is embedded in the inner wall 315A of the case body 315 in a state where the resin that forms the inner wall 315A of the case body 315 has entered a plurality of pores contained in the surface of the adsorbent agglomerate 319.

In the aforementioned evaporated fuel treatment device 301, the evaporated fuel introduced from the charge port 21 is adsorbed on the adsorbent 5 in the first adsorption chamber 5R. The evaporated fuel that could not be fully adsorbed in the first adsorption chamber 5R moves through the communication path 6 to the second adsorption chamber 7R, and then is adsorbed on the adsorbent 7 in the second adsorption chamber 7R.

The evaporated fuel that could not be fully adsorbed in the second adsorption chamber 7R moves through the atmosphere port 23 and the connecting pipe 308 and flows into an inner space of the cartridge 310 that includes the adsorbent agglomerate 319 therein. The inner space of the cartridge 310 functions as the third adsorption chamber. The evaporated fuel flowing into the inner space of cartridge 310 is adsorbed on the adsorbent agglomerate 319. The gas from which the evaporated fuel has been removed by adsorption is released from the atmosphere port 313A of the cartridge 310.

In addition to the above, with air supply from the atmosphere port 313A, the evaporated fuels that have been adsorbed on the adsorbents 5, 7, and the adsorbent agglomerate 319 are discharged from the purge port 22 to the engine. As a result of the discharge, the evaporated fuel is supplied to the engine.

Also in the present embodiment, similarly to the first embodiment, the adsorbent agglomerate 319 is provided in the cartridge 310 by insert molding, so that it is possible to reduce the breakage of the adsorbent agglomerate 319 caused by compression and the increased ventilation resistance. An additional advantage of the present embodiment is that the cartridge 310 can be easily replaced. It is possible to easily replace the adsorbent agglomerate 319 that has been deteriorated.

### Other Embodiments

The present disclosure is not limited to the above-described embodiments and can have various configurations. For example, depending on shapes of the hollow case 11, the outer case 202, or the case body 315, the adsorbent agglomerates 9, 15, 209, and 319 can have various shapes such as a round column shape, a rectangular parallelepiped shape, or a square column shape. The adsorbent agglomerates 9, 15, 209, and 319 may have a bellows shape. The bellows-shaped adsorbent agglomerate can be a bellows-shaped adsorbent agglomerate that has a periodical waveform along a direction perpendicular to a ventilation direction.

The technique of the present disclosure is very meaningful for the adsorbent agglomerate that might be damaged by compression. The adsorbent agglomerates 9, 15, 209, and 319 are not limited to agglomerates of activated carbon or zeolite, and may be agglomerates of other adsorbents that might be damaged by compression. The adsorbent agglomerates 9, 15, 209, and 319 may be porous bodies with micro pores. The adsorbent agglomerates 9, 15, 209, and 319 may be agglomerates of ceramics.

The functions of a single element in the above-described embodiments may be provided in two or more elements in a distributed manner. The functions of two or more elements may be integrated in a single element. Part of the configuration in the above-described embodiments may be omitted. At least part of the configuration of the above-described embodiments may be added to or replaced by a configuration of other embodiments. Any and all modes encompassed by the technical ideas specified by the language of the claims are embodiments of the present disclosure.

### Technical Ideas Disclosed Herein

It is to be understood that this specification discloses technical ideas as below.

### Item 1

An evaporated fuel treatment device comprising:
a hollow case including an inner wall that defines an inner space of the hollow case; and
an adsorbent agglomerate accommodated in the inner space that is surrounded by the inner wall of the hollow case, the adsorbent agglomerate being configured to adsorb an evaporated fuel flowing into the inner space,
the adsorbent agglomerate being accommodated in the inner space in a state where a peripheral part of the adsorbent agglomerate is at least partially embedded in the inner wall of the hollow case.

### Item 2

The evaporated fuel treatment device according to item 1,
wherein the adsorbent agglomerate has a surface with porosity, and is embedded in the inner wall in a state where a material forming the inner wall has entered a plurality of pores contained in the surface.

### Item 3

The evaporated fuel treatment device according to item 1 or 2,
wherein the adsorbent agglomerate is accommodated in the inner space of the hollow case such that the peripheral part of the adsorbent agglomerate is at least partially embedded in the inner wall of the hollow case by forming the hollow case including the adsorbent agglomerate by insert molding.

### Item 4

The evaporated fuel treatment device according to any one of items 1 through 3,
wherein the adsorbent agglomerate has a circumferential edge arranged along the inner wall, and the circumferential edge is embedded in the inner wall.

### Item 5

The evaporated fuel treatment device according to any one of items 1 through 4, further comprising:
an outer case including a charge port for the evaporated fuel, the outer case forming therein a flow passage for a gas containing the evaporated fuel flowing in from the charge port,
wherein the hollow case accommodating the adsorbent agglomerate is formed as a separate member from the outer case and is arranged in the flow passage for the gas, in the outer case.

### Item 6

The evaporated fuel treatment device according to any one of claims 1 through 4,
wherein the hollow case including:
   a case body including an open end and the inner wall that defines the inner space, the case body accommodating the adsorbent agglomerate; and
   a lid configured to be attached to the case body at a specified position in the case body so as to close at least a part of the open end.

### Item 7

A manufacturing method of an evaporated fuel treatment device including a hollow case and an adsorbent agglomerate, the manufacturing method comprising:
preparing a mold to form the hollow case, the hollow case including an inner wall that defines an inner space of the hollow case;
arranging the adsorbent agglomerate in a specified position inside the mold, the adsorbent agglomerate being configured to adsorb an evaporated fuel; and
filling a resin to form the hollow case inside the mold in a state where the adsorbent agglomerate is arranged inside the mold,
wherein the evaporated fuel treatment device is manufactured by filling the resin inside the mold, and the adsorbent agglomerate is accommodated in the inner space of the hollow case in a state where the peripheral part of the adsorbent agglomerate is at least partially embedded in the inner wall of the hollow case by insert molding.

### Item 8

The manufacturing method of an evaporated fuel treatment device according to item 7,
wherein the hollow case includes, as the inner wall, a cylindrical inner wall having a central axis,
wherein the adsorbent agglomerate has a columnar outer shape having a central axis,
wherein the mold and the adsorbent agglomerate include respective positioning structures to align the central axis of the adsorbent agglomerate with the central axis of the hollow case, and
wherein the arranging the adsorbent agglomerate includes arranging the adsorbent agglomerate in the specified position inside the mold by positioning the adsorbent agglomerate with respect to the mold using the respective positioning structures.

What is claimed is:

1. An evaporated fuel treatment device comprising:
a hollow case including an inner wall that defines an inner space of the hollow case; and
an adsorbent agglomerate accommodated in the inner space that is surrounded by the inner wall of the hollow case, the adsorbent agglomerate being configured to adsorb an evaporated fuel flowing into the inner space,
the adsorbent agglomerate being accommodated in the inner space in a state where a peripheral part of the adsorbent agglomerate is at least partially embedded in the inner wall of the hollow case.

2. The evaporated fuel treatment device according to claim 1,
wherein the adsorbent agglomerate has a surface with porosity, and is embedded in the inner wall in a state where a material forming the inner wall has entered a plurality of pores contained in the surface.

3. The evaporated fuel treatment device according to claim 1,
wherein the adsorbent agglomerate is accommodated in the inner space of the hollow case such that the peripheral part of the adsorbent agglomerate is at least partially embedded in the inner wall of the hollow case by forming the hollow case including the adsorbent agglomerate by insert molding.

4. The evaporated fuel treatment device according to claim 1,
wherein the adsorbent agglomerate has a circumferential edge arranged along the inner wall, and the circumferential edge is embedded in the inner wall.

5. The evaporated fuel treatment device according to claim 1, further comprising:
an outer case including a charge port for the evaporated fuel, the outer case forming therein a flow passage for a gas containing the evaporated fuel flowing in from the charge port,
wherein the hollow case accommodating the adsorbent agglomerate is formed as a separate member from the outer case and is arranged in the flow passage for the gas, in the outer case.

6. The evaporated fuel treatment device according to claim 1,
wherein the hollow case including:
a case body including an open end and the inner wall that defines the inner space, the case body accommodating the adsorbent agglomerate; and
a lid configured to be attached to the case body at a specified position in the case body so as to close at least a part of the open end.

7. A manufacturing method of an evaporated fuel treatment device including a hollow case and an adsorbent agglomerate, the manufacturing method comprising:
preparing a mold to form the hollow case, the hollow case including an inner wall that defines an inner space of the hollow case;
arranging the adsorbent agglomerate in a specified position inside the mold, the adsorbent agglomerate being configured to adsorb an evaporated fuel; and
filling a resin to form the hollow case inside the mold in a state where the adsorbent agglomerate is arranged inside the mold,
wherein the evaporated fuel treatment device is manufactured by filling the resin inside the mold, and the adsorbent agglomerate is accommodated in the inner space of the hollow case in a state where the peripheral part of the adsorbent agglomerate is at least partially embedded in the inner wall of the hollow case by insert molding.

8. The manufacturing method of an evaporated fuel treatment device according to claim 7,
wherein the hollow case includes, as the inner wall, a cylindrical inner wall having a central axis,
wherein the adsorbent agglomerate has a columnar outer shape having a central axis,
wherein the mold and the adsorbent agglomerate include respective positioning structures to align the central axis of the adsorbent agglomerate with the central axis of the hollow case, and
wherein the arranging the adsorbent agglomerate includes arranging the adsorbent agglomerate in the specified position inside the mold by positioning the adsorbent agglomerate with respect to the mold using the respective positioning structures.
